(19) United States
(12) Patent Application Publication
(10) Pub. No.: US 2010/0257167 A1
(43) Pub. Date: Oct. 7, 2010

(54) LEARNING TO RANK USING QUERY-DEPENDENT LOSS FUNCTIONS

(75) Inventor: Tie-Yan Liu, Beijing (CN)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/416,919

(22) Filed: Apr. 1, 2009

(51) Int. Cl. G06F 17/30

(52) U.S. Cl. 707/731; 707/E17.017

(57) ABSTRACT

Queries describe users' search needs and therefore they play a role in the context of learning to rank for information retrieval and Web search. However, most existing approaches for learning to rank do not explicitly take into consideration the fact that queries vary significantly along several dimensions and require different objectives for the ranking models. The technique described herein incorporates query difference into learning to rank by introducing query-dependent loss functions. Specifically, the technique employs query categorization to represent query differences and employs specific query-dependent loss functions based on such kind of query differences. The technique employs two learning methods. One learns ranking functions with pre-defined query difference, while the other one learns both of them simultaneously.

Ranking has become an important research issue for information retrieval and Web search, since the quality of a search system is mainly evaluated by the relevance of its ranking results. The task of ranking in a search process can be briefly described as follows. Given a query, the deployed ranking model measures the relevance of each document to the query, sorts all documents based on their relevance scores, and presents a list of top-ranked ones to the user. Thus, a key problem of search technology is to develop a ranking model that can best represent relevance.

Many models have been proposed for ranking, including a Boolean model, a vector space model, a probabilistic model, and a language model. Recently, there is renewed interest in exploring machine learning methodologies for building ranking models, now generally known as learning to rank. Example approaches include point-wise ranking models, pair-wise ranking models and list-wise ranking models. These approaches leverage training data, which consists of queries with their associated documents and relevance labels, and machine learning techniques to make the tuning of ranking models theoretically sound and practically effective.

In most ranking algorithms, queries tend to be treated in the same way in the context of learning to rank. However, queries vary largely in semantics and users' search intentions and query-class. For example, queries can be different in terms of search intentions which can be coarsely categorized as navigational, informational and transactional. As another example, queries can vary in terms of relational information needs, including queries for subtopic retrieval and topic distillation.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The query-dependent loss ranking technique described herein incorporates query differences into learning to rank by introducing query-dependent loss functions. Specifically, the technique employs query categorization to represent query differences and develops specific query-dependent loss functions based on such kind of query differences. In one embodiment, the technique learns an optimal search result ranking function by minimizing query-dependent loss functions. The technique can employ two learning methods—one learns ranking functions with pre-defined query differences, while the other one learns both the query categories and ranking function simultaneously.

In the following description of embodiments of the disclosure, reference is made to the accompanying drawings which form a part hereof, and in which are shown, by way of illustration, specific embodiments in which the technique may be practiced. It is understood that other embodiments may be utilized and structural changes may be made without departing from the scope of the disclosure.

### DESCRIPTION OF THE DRAWINGS

The specific features, aspects, and advantages of the disclosure will become better understood with regard to the following description, appended claims, and accompanying drawings where:

FIG. 1 is a flow diagram depicting an exemplary embodiment of a process for employing the query-dependent loss ranking technique described herein.

FIG. 2 is a flow diagram depicting another exemplary embodiment of a process for employing the query-dependent loss ranking technique described herein.

FIG. 3 is an exemplary system architecture in which one embodiment of the query-dependent loss ranking technique can be practiced.

FIG. 4 is a schematic of an exemplary computing device which can be used to practice the query-dependent loss ranking technique.

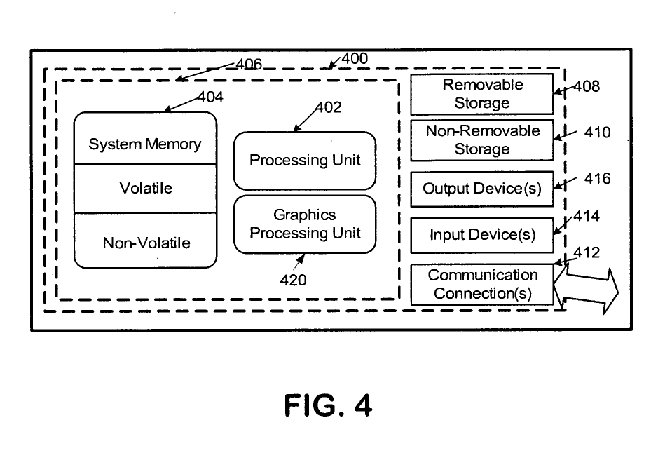

### DETAILED DESCRIPTION

In the following description of the query-dependent loss ranking technique, reference is made to the accompanying drawings, which form a part thereof, and which show by way of illustration examples by which the query-dependent loss ranking technique described herein may be practiced. It is to be understood that other embodiments may be utilized and structural changes may be made without departing from the scope of the claimed subject matter.

### 1.0 QUERY-DEPENDENT LOSS RANKING TECHNIQUE

The following paragraphs provide an introduction to the query-dependent loss ranking technique described herein. A description of a framework for employing the technique, as well as exemplary processes and an exemplary architecture for employing the technique are also provided. Throughout the following description details and associated computations are described.

### 1.1 INTRODUCTION

The query-dependent loss ranking technique described herein provides a general framework that incorporates query difference into learning to rank by introducing query-dependent loss functions. Specifically, the technique employs query categorization to represent query differences and develops specific query-dependent loss functions based on such kind of query differences. The technique employs two learning methods—one learns a ranking function with pre-defined query differences, while the other one learns both the query categories and ranking function simultaneously. Application of the technique to two existing ranking algorithms, RankNet and ListMLE, demonstrate that query-dependent loss functions can additionally be exploited to significantly improve the accuracy of existing learned ranking functions.

The technique described herein recognizes that different queries require different objectives for ranking models. For instance, for a navigational or transactional query, the ranking model should aim to rank the exact Web page that the user is looking for at the top of the result list; while for an informational query, the ranking model should try to let a set of Web pages relevant to the topic of the query be ranked at top positions of the returned results. As another example, queries for subtopic retrieval should have top-ranked documents covering as many subtopics as possible; while queries for topic distillation should select a few documents to best represent a topic. Thus, the present technique takes into account query differences in learning to rank in order to satisfy the diverse objectives of queries.

### 1.2 GENERAL FRAMEWORK OF THE TECHNIQUE

The following paragraphs provide a description of how the query-dependent loss ranking technique incorporates query differences into loss functions for learning to rank search results. Learning methods and query dependent loss functions are discussed. Additionally, a detailed description of a specific application of the technique is provided.

### 1.2.1 INCORPORATING QUERY DIFFERENCE INTO LOSS FUNCTIONS

The problem of learning to rank can be formalized as computing a ranking function ƒεF, where F is a given function class, such that ƒ minimizes the risk of ranking in the form of a given loss function L_{ƒ}. For a general learning to rank approach, the loss function is defined as:

$${L}_{f} = {\sum }_{q ∈ Q} L ( f ) , \qquad ( 1 )$$

where Q denotes the set of queries in the training data; L(ƒ) denotes a query-level loss function, which is defined on ranking function ƒ and has the same form among all queries.

The present query-dependent loss ranking technique incorporates query difference into the loss function by applying different loss functions to different queries. This kind of query-dependent loss function is defined as:

$${L}_{f} = {\sum }_{q ∈ Q} L ( f ; q ) , \qquad ( 2 )$$

where L(ƒ;q) is the query-level loss function defined on both query q and ranking function ƒ, and each query has its own form of loss function.

However, it is difficult and expensive in practice to define an individual objective for each query. Thus, the technique takes advantage of query categorization to represent query differences, which means each query category stands for one kind of ranking objective. In general, the technique assumes there is a query category space, denoted as C={C₁, . . . , Cₘ}, where Cᵢ(i=1, . . . , m) represents one query category. The technique also assumes a soft query categorization, which means each query can be described as a distribution over this space. One uses P(Cᵢ|q) to denote the probability that query q belongs to the class Cᵢ with

$${\sum }_{i = 1}^{m} P ( {C}_{i} \vert q ) = 1.$$

Thus, the query-dependent loss function of the ranking function ƒ is defined as:

$$\begin{matrix}{L}_{f} = {\sum }_{q ∈ Q} L ( f ; q ) & ( 3 ) \\ = {\sum }_{q ∈ Q} ( {\sum }_{i = 1}^{m} P ( {C}_{i} \vert q ) L ( f ; q , {C}_{i} ) ) , & ( 4 )\end{matrix}$$

where L(ƒ;q,C) denotes a category-level loss function defined on query q, ranking function ƒ and q's category C.

### 1.2.2 LEARNING METHODS

After constructing the query-dependent loss function by incorporating the information of query categories, the technique, in one embodiment, can use two different methods for learning the ranking function. In the first method, the technique first obtains the soft categorization for each query, i.e. P(Cᵢ|q), i=1, . . . , m. Then, it learns the ranking function by minimizing the query-dependent loss function (Eq. 4) with known query categorization. In this method, the query categorization is performed independently from learning the ranking function. This method is denoted as the stage-wise method herein. However, query categorization may not be available at the learning time. Thus, in one embodiment, the technique employs another method which learns the ranking function jointly with query categorization. Compared to the stage-wise one, this method aims to categorize queries for the purpose of minimizing the loss function for ranking. This method is called the unified method herein.

As presented previously, the technique use explicit query categories (the stage-wise approach) or query-specific features (the unified approach) to learn ranking models with query-dependent loss functions. However, when the technique employs a trained ranking model to perform ranking on new queries, it does not use any information of query classes or query-specific features for the new query. The reason that ranking models using query-dependent loss functions can outperform the original ranking models even without using query-specific information at query time is as follows: Although query-specific classes and features are not available at query time, they can be viewed as extra tasks for the learner. Therefore, this query-specific information of training data sets (e.g., informational and navigational) is transferred into other common features as training signals. One can benefit from ranking models with query-dependent loss functions due to the information in the extra training signals serving as a query-specific inductive bias for ranking.

### 1.2.3 QUERY-DEPENDENT LOSS FUNCTIONS

Given the general framework of query-dependent loss functions with incorporated query categories (Eq. 4), the technique can employ a number of possible approaches to give a specific definition of the query-dependent loss functions L(ƒ;q,Cᵢ), according to different kinds of query categorization.

For example, under a certain query categorization, it may be better to employ different metrics to indicate ranking performance for different query categories. In particular, for some queries, the known NDCG (Normalized Discounted Cumulative Gain) metric is a good metric while for other queries, MAP (Mean Average Precision) is a good metric. For such query categorization, the technique can build the query-dependent loss function by exploiting the individual good or best metric for each query category. Under other kinds of query categorization, different query categories may represent intentions of different rank positions. Some queries may require high accuracy on a certain set of rank positions; while others may focus the ranking objective for another set of positions. For such query categorization, the technique can define the query-dependent loss function by targeting the respective set of rank positions for different query categories.

### 1.3 APPLICATION TO A SPECIFIC QUERY CATEGORIZATION

In this section, a description of the general framework as applied is provided using a particular query categorization and a corresponding defined query-dependent loss function.

### 1.3.1 A SPECIFIC QUERY CATEGORIZATION

In terms of search intentions, in one embodiment of the technique, queries are classified into three major categories: navigational, informational, and transactional. A navigational query is intended to locate a specific Web page, which is often the official homepage or sub-page of a site. An informational query seeks information on the query topic. A transactional query seeks to complete a transaction on the Web. Different search intentions of queries indicate different objectives for the ranking model. Specifically, for the navigational and transactional query, the ranking model aims to rank the exact relevant Web page at the top one position in the result set; while for the informational query, the ranking model tries to rank a set of relevant Web pages at the top positions in the result set.

The following paragraphs demonstrate how to employ query-dependent loss functions in the technique in order to satisfy these position-sensitive objectives. And, since rank objectives for these query categories are much related to rank positions, a position-based approach to define a query-dependent loss function employed in one embodiment of the query-dependent loss ranking technique is introduced.

### 1.3.2 QUERY DEPENDENT LOSS FUNCTIONS

According to the ranking objective discussed above, in one embodiment of the technique, queries are classified into two categories, i.e., C={C_{I}, C_{N}}, where C_{I} denotes informational queries and C_{N} denotes navigational and transactional queries. Note that this embodiment of the technique combines navigational and transactional queries into C_{N} since both of these describe a similar search intention which focuses on the accuracy of the top-one ranked result versus a set of top ranked results.

According to Eq. 4, the query-dependent loss function is now defined as:

L(ƒ;q)=α_{q}L(ƒ;q,C_{I})+β_{q}L(ƒ;q,C_{N}), (5)

where α_{q}=P(C_{I}|q) represents the probability that q is an informational query, β_{q}=P(C_{N}|q) indicates the probability that q is a navigational or transactional query, and α_{q}+β_{q}=1. For informational queries, the technique focuses the ranking risk, L(ƒ;q,C_{I}), on a list of documents which should be ranked on a certain range of top positions; while for navigational and transactional queries, the technique only considers the ranking risk, L(ƒ;q,C_{N}), on the documents which should be ranked on the top-one position.

### 1.3.2.1 ESTIMATING RANK POSITIONS FROM RELEVANCE JUDGMENTS

As discussed above, in order to build the query-dependent loss function, the technique needs to obtain the true rank positions of training examples. The relevance judgments in the training set provide the possibility to obtain the true rank position of each training example. Multi-level relevance judgments can be used in the training set. For example, if all the training examples are labeled using a k-level relevance judgment, the label set contains k distinct relevance levels, such as {0, 1, . . . , k-1}, where larger value usually indicates higher relevance.

However, there is an apparent gap between the true rank positions and multi-level relevance judgments. In particular, for some queries, more than one document may have the same label, in which case the technique is not able to tell the exact rank positions for these documents. Therefore, it is desirable to find a precise method to map the relevance labels into rank positions. A general method employed by one embodiment of the technique is to utilize labels to estimate the probability that one document is ranked at each position for the given query, so that all the documents with the same label have equal probability to be ranked at the same position, and those with better relevance labels have higher probability to be ranked at higher positions. There are many specific methods for implementing this general method. One is based on the equivalent correct permutation set. Given a query q, the technique assumes all of the documents under q are labeled using a k-level relevance judgment; and for each label level t,(t ε{0,1, . . . , k-1}), the technique assumes that there are nₜ documents under q whose labels are t. For the document list under q, the technique defines an equivalent correct permutation set S:

S={τ|l(dᵢ)>l(dⱼ) [symbol] τ(dᵢ)<τ(dⱼ)} (6)

which means, for each permutation τεS, if the label of one document dᵢ is better than another document dⱼ, i.e. l(dᵢ)>l(dⱼ), then the position of dᵢ in τ is higher than that of dⱼ, i.e., τ(dᵢ)<τ(dⱼ). Then, the probability that a document d with label t is ranked at certain position p can be defined as:

$$P ( d @ p ) = \frac{1}{\vert S \vert} {\sum }_{τ ∈ S} {1}_{\{ d @ pin τ \}} , \qquad ( 7 )$$

where 1_{{d(α)pinτ}} is an indicator function which equals 1 if document d is at position p in permutation τ and otherwise 0. Then, the probability can be calculated as:

$$P ( d @ p ) = \{ \begin{matrix}\frac{1}{{n}_{t}} & 1 + {\sum }_{m = t + 1}^{k - 1} {n}_{m} \leq p \leq {\sum }_{m = t}^{k - 1} {n}_{m} \\ 0 & otherwise\end{matrix}$$

For example, assume under a query q, there are five documents {a,b,c,d,e}. A three-level labeling is used. Assume the label set is {0,1,2} where 2 means highest relevance. Assume the labels of five documents are {2,2,1,1,0} respectively. Based on the above method, both a and b have probability 50% to be ranked at position 1 and 2, and 0 at other positions; both c and b have probability 50% to be ranked at position 3 and 4, and 0 at other positions; e has probability 100% to be ranked at position 5. This probability, which is also represented as P(p(i) in later computations, is then used in computing the query-dependent loss function.

### 1.3.2.2 TWO LEARNING METHODS

To learn the ranking function, the technique seeks to minimize a query-dependent loss function. As discussed before, the technique can employ both stage-wise and unified methods in the general framework.

(a) Stage-wise Method: In the stage-wise learning method, the technique obtains a pre-defined categorization for each query before learning the ranking function. In particular, in one exemplary embodiment, for pre-defined informational queries α_{q}=1,β_{q}=0; while for pre-defined navigational or transactional queries, α_{q}=0,β_{q}=1. In one embodiment, the technique employs a gradient descent method with respect to these parameters of the ranking function to minimize the query-dependent loss function.

(b) Unified Method: In the unified method, due to unavailable knowledge on query categories, one embodiment of the technique learns both the query categorization and the ranking function simultaneously. One embodiment of the technique assumes z_{q} is a feature vector of query q and γ is a vector of parameters of query categorization, and uses a logistic function to obtain the query categorization α_{q} and β_{q} from query features:

$${α}_{q} = \frac{exp ( < γ , {z}_{q} > )}{1 + exp ( < γ , {z}_{q} > )} , {β}_{q} = \frac{1}{1 + exp ( < γ , {z}_{q} > )} , \qquad ( 8 )$$

where (<·,·>) denotes the usual inner product. Similar to the stage-wise method, the technique uses a gradient descent method, but with an additional parameter vector γ, to minimize the query-dependent loss function.

Note that, since the technique does not need information of query categories during testing, γ will not be used for ranking during testing; but γ can be used to compute the query categorization of testing queries.

### 1.4 EXAMPLE QUERY-DEPENDENT LOSS FUNCTIONS AS APPLIED TO EXISTING RANKING ALGORITHMS

The position-based query-dependent loss function can be applied to existing ranking algorithms. For example, the query-dependent loss function technique can be applied to two existing ranking procedures—the pair-wise method RankNet and the list-wise method ListMLE.

To build query-dependent loss functions, one embodiment of the technique assumes that, for navigational and transactional queries, the ranking objective aims to rank k_{N} most relevant documents on top positions; while for informational queries, it seeks to rank k_{I} most relevant documents on top positions. Here k_{N} and k_{I} are two parameters of the loss functions employed in one embodiment of the technique.

### 1.4.1 EXAMPLE I

### Query-Dependent Loss Functions for RankNet

RankNet is a pair-wise ranking algorithm using a loss function that depends on the difference of the outputs of pairs of training samples xᵢ [symbol] xⱼ which indicates xᵢ should be ranked higher than xⱼ. The loss function is minimized when the document xᵢ with a higher relevance label receives a higher score, i.e., when ƒ(xᵢ)>ƒ(xⱼ). One embodiment of the technique is employed with RankNet. Mathematically, this can be described as follows. Let Pᵢⱼ denote the probability P(xᵢ [symbol] xⱼ), and let P̅ᵢⱼ denote the desired target values. More specifically, if xᵢ is ranked before xⱼ according to the ground truth, this target value is 1, otherwise it is zero.

Define oᵢ≡ƒ(xᵢ) and oᵢⱼ≡ƒ(xᵢ)−ƒ(xⱼ). RankNet uses the cross entropy loss function:

L(oᵢⱼ)=− P̅ᵢⱼ log Pᵢⱼ−(1− P̅ᵢⱼ)log(1−Pᵢⱼ),

where a map from outputs to probabilities are modeled using a logistic function: Pᵢⱼ≡e^{o}^{ᵢⱼ}/(1+e^{o}^{ᵢⱼ}). Then the final cost thus becomes: L(oᵢⱼ)=− P̅ᵢⱼoᵢⱼ+log(1+e^{o}^{ᵢⱼ}).

For a pair of documents, (xᵢ,xⱼ), assume p(i) and p(j) are true ranking positions for xᵢ and xⱼ, respectively; L(oᵢⱼ) will be added into the loss function for navigational and transactional queries if only p(i)≦k_{N} or p(j)≦k_{N}; Similarly, L(oᵢⱼ) will be added into the total loss for informational queries if only p(i)≦k_{I} or p(j)≦k_{I}. To this end, the query-dependent loss function of RankNet for each pair can be defined as:

$$L ( {o}_{ij} , q ) = {\sum }_{p ( i ) = 1}^{{n}_{q}} P ( p ( i ) \vert {x}_{i} , g ( {x}_{i} ) ) ( \begin{matrix}{α}_{q} \cdot {1}_{\{ p ( i ) \leq {k}_{I} \}} + \\ {β}_{q} \cdot {1}_{\{ p ( i ) \leq {k}_{N} \}}\end{matrix} ) \cdot L ( {o}_{ij} ) ,$$

where n_{q} is the number of associated documents for query q; P(p(i)|xᵢ, g(xᵢ)) is the probability that xᵢ with label g(xᵢ) is ranked at position p(i).

### 1.4.2 EXAMPLE II

### Query-Dependent Loss Functions

ListMLE is a listwise ranking algorithm, which learns a ranking function by taking individual lists as instances and minimizing a loss function defined on the predicted list and the truth list. In particular, ListMLE formalizes learning to rank as a problem of minimizing the likelihood function of a probability model. ListMLE seeks to minimize top-k surrogate likelihood loss, which is defined as:

L(ƒ;q)=φ(Π_{ƒ}(x),y)=−log P_{y}^{k}(Π_{ƒ}(x))

where x={x₁, . . . , xₙ} is the list of documents, and n is the number of associated document for query q; y={y(1), . . . , y(n)} is the true permutation of documents under q, and y(i) denotes the index of document which is ranked at position i; φ is a surrogate loss function; Π_{ƒ}(x)={ƒ(x₁), . . . ,ƒ(xₙ)} denotes the permutation ordered by ranking function ƒ; and P_{y}^{k}(Π_{ƒ}(x)) is defined as:

$${P}_{y}^{k} ( {Π}_{f} ( x ) ) = {\prod }_{j = 1}^{k} \frac{exp ( f ( {x}_{y ( j )} ) )}{{\sum }_{t = j}^{n} exp ( f ( {x}_{y ( t )} ) )}$$

where k is the parameter which infers that parameterized negative top-k log-likelihood with plackeet-Luce model is used as the surrogate loss.

To build the query-dependent loss function, in one embodiment of the technique, top-k_{N} surrogate likelihood loss is used for navigational or transactional queries while top-k_{I} surrogate likelihood loss is used for informational queries. To this end, the query-dependent loss function of ListMLE for each query can be defined as:

L(ƒ;q)=−α_{q} log P_{y}^{k}^{_{I}}(Π_{ƒ}(x))−β_{q} log P_{y}^{k}^{_{N}}(Π_{ƒ}(x)) (9)

Note that ListMLE has integrated rank positions into its loss function, the technique does not need to additionally estimate rank positions from relevance labels.

To learn the ranking functions using query-dependent loss functions for RankNet and ListMLE, the technique can employ both the stage-wise and unified learning methods. As described previously, the technique can use the gradient descent method to minimize the query-dependent loss functions. Note that, for the stage-wise method, the technique only needs to compute the negative gradient of the query-dependent loss function with respect to parameters of the ranking function; while for the unified method, the technique computes the negative gradient with respect to both parameters of the ranking function as well as those of the query categorization, i.e. γ defined in Eq. 8. As a byproduct, it should be noted that the values of γ after optimization can be used to compute query categorization. The computation of the negative gradients, though tedious, is rather standard and will not be presented here.

An overview of the framework of the technique, a specific application of the technique to particular categories and an application of the technique to existing learning to rank algorithms having been described, the next sections will discuss exemplary processes and an exemplary architecture for employing the technique.

### 1.5 EXEMPLARY PROCESSES EMPLOYED BY THE QUERY-DEPENDENT LOSS RANKING TECHNIQUE

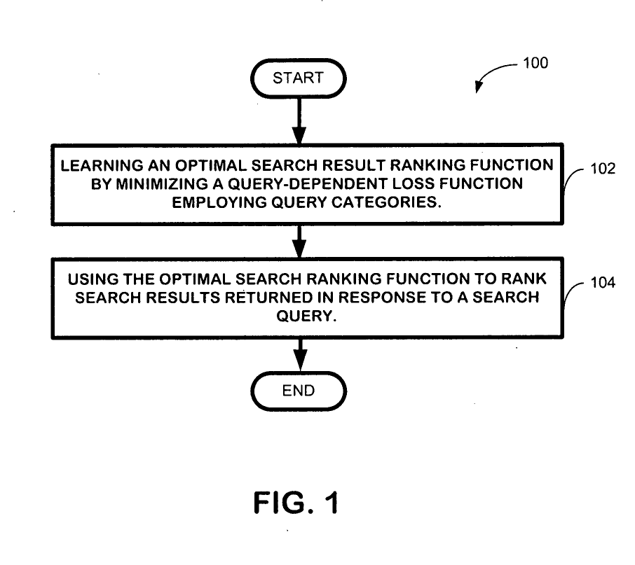

An exemplary process 100 employing the query-dependent loss ranking technique is shown in FIG. 1. As shown in FIG. 1, block 102, the technique learns an optimal search result ranking function, using a set of predicted query categories and training data, by minimizing a query-dependent loss function. The training data can include a set of training queries and their associated returned documents (search results) and positional ranking. Once the optimal search ranking function is trained it can then be used to rank search results returned in response to a new search query, as shown in block 104

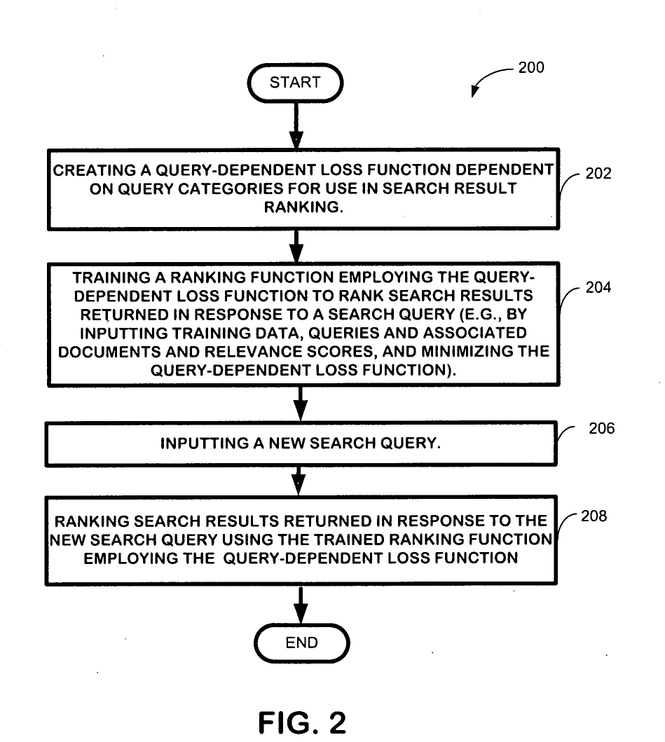

Another exemplary process 200 for employing the query-dependent loss ranking technique is shown in FIG. 2. A query-dependent loss function dependent on query categories for use in search result ranking is created, as shown in block 202. It should be noted that the query dependent loss functions can be composited from a loss function for each different query category or type to create the overall query-dependent loss function. A ranking function employing the (overall) query-dependent loss function can then be trained to learn to rank results returned in response to a search query, as shown in block 204. For example, this can be done by inputting a set of queries of different types and their associated returned documents and relevance scores, and using this data to minimize the query dependent loss function in the ranking function. If positional ranking data is not available in the training data, relevance data can be used to estimate positional ranking of the returned documents. Additionally, in one embodiment of the query-dependent loss ranking technique, query categories can be learned at the same time that the ranking function is learned. Once the ranking function is trained, a new search query can then be input (block 206). Search results returned in response to the new search query can be ranked according to the desired ranking objective for different query types using the trained ranking function (block 208).

### 1.6 EXEMPLARY ARCHITECTURE EMPLOYING THE INCREMENTAL FORUM WEB CRAWLING TECHNIQUE

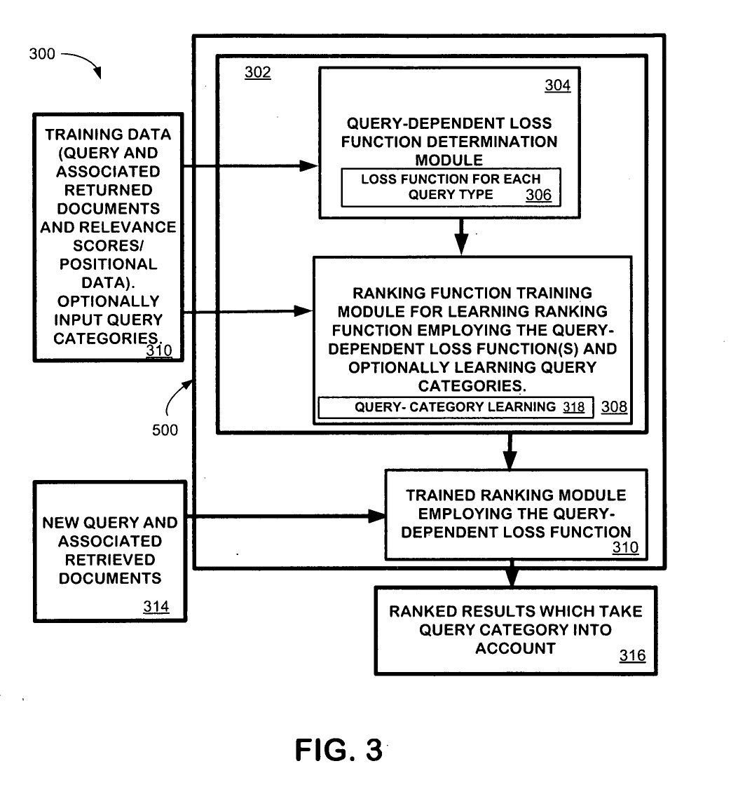

FIG. 3 provides one exemplary architecture 300 in which one embodiment of the query-dependent loss ranking technique can be practiced. As shown in FIG. 3, block 302, the architecture 300 employs a query-dependent loss function learning module 302, which typically resides on a general computing device 500 such as will be discussed in greater detail with respect to FIG. 5. Additionally, the architecture includes a query-dependent loss function determination module 304 that determines a query-dependent loss function for each of the query categories or types 306. These query-dependent loss functions can be summed to create an overall query-dependent loss function. Once the overall query-dependent loss function is created (e.g., composed of the summed loss functions) a ranking function training module 308 trains a ranking function that employs the overall query-dependent loss function. This training module 308 receives training data to learn the ranking function. This training data 310 includes training queries and their associated search results and relevancy rating or positional ranking. The training data 310 and the ranking function training module 308 are used to create a trained ranking model 312 that employs the query-dependent loss function. As described previously, the technique can use the gradient descent method to minimize the query-dependent loss function in order to create the trained ranking model 312. The trained model 312 can then be used to rank the search results in response to a new query 314 taking into account the query type in the ranking. The ranked results 316 are then output and can be used for various applications.

In one embodiment of the technique, the query categories 318 are learned in conjunction with training the ranking model 312. As discussed previously, the technique can employ the unified learning method to learn the query categories. Alternately, instead of learning the query categories, the technique can use predetermined query categories.

### 2.0 THE COMPUTING ENVIRONMENT

The query-dependent loss ranking technique is designed to operate in a computing environment. The following description is intended to provide a brief, general description of a suitable computing environment in which the query-dependent loss ranking technique can be implemented. The technique is operational with numerous general purpose or special purpose computing system environments or configurations. Examples of well known computing systems, environments, and/or configurations that may be suitable include, but are not limited to, personal computers, server computers, hand-held or laptop devices (for example, media players, notebook computers, cellular phones, personal data assistants, voice recorders), multiprocessor systems, microprocessor-based systems, set top boxes, programmable consumer electronics, network PCs, minicomputers, mainframe computers, distributed computing environments that include any of the above systems or devices, and the like.

FIG. 5 illustrates an example of a suitable computing system environment. The computing system environment is only one example of a suitable computing environment and is not intended to suggest any limitation as to the scope of use or functionality of the present technique. Neither should the computing environment be interpreted as having any dependency or requirement relating to any one or combination of components illustrated in the exemplary operating environment. With reference to FIG. 5, an exemplary system for implementing the query-dependent loss ranking technique includes a computing device, such as computing device 500. In its most basic configuration, computing device 500 typically includes at least one processing unit 502 and memory 504. Depending on the exact configuration and type of computing device, memory 504 may be volatile (such as RAM), non-volatile (such as ROM, flash memory, etc.) or some combination of the two. This most basic configuration is illustrated in FIG. 5 by dashed line 506. Additionally, device 500 may also have additional features/functionality. For example, device 500 may also include additional storage (removable and/or non-removable) including, but not limited to, magnetic or optical disks or tape. Such additional storage is illustrated in FIG. 5 by removable storage 508 and non-removable storage 510. Computer storage media includes volatile and nonvolatile, removable and non-removable media implemented in any method or technology for storage of information such as computer readable instructions, data structures, program modules or other data. Memory 504, removable storage 508 and non-removable storage 510 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 500. Any such computer storage media may be part of device 500.

Device 500 also contains communications connection(s) 512 that allow the device to communicate with other devices and networks. Communications connection(s) 512 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal, thereby changing the configuration or state of the receiving device of the signal. By way of example, and not limitation, communication media includes wired media such as a wired network or direct-wired connection, and wireless media such as acoustic, RF, infrared and other wireless media. The term computer readable media as used herein includes both storage media and communication media.

Device 500 may have various input device(s) 514 such as a display, a keyboard, mouse, pen, camera, touch input device, and so on. Output device(s) 516 such as speakers, a printer, and so on may also be included. All of these devices are well known in the art and need not be discussed at length here.

The query-dependent loss ranking technique may be described in the general context of computer-executable instructions, such as program modules, being executed by a computing device. Generally, program modules include routines, programs, objects, components, data structures, and so on, that perform particular tasks or implement particular abstract data types. The query-dependent loss ranking technique may be practiced in distributed computing environments where tasks are performed by remote processing devices that are linked through a communications network. In a distributed computing environment, program modules may be located in both local and remote computer storage media including memory storage devices.

It should also be noted that any or all of the aforementioned alternate embodiments described herein may be used in any combination desired to form additional hybrid embodiments. Although the subject matter has been described in language specific to structural features and/or methodological acts, it is to be understood that the subject matter defined in the appended claims is not necessarily limited to the specific features or acts described above. The specific features and acts described above are disclosed as example forms of implementing the claims.

Wherefore, what is claimed is:

1. A computer-implemented process for ranking results returned in response to a search query, comprising:
learning an optimal search result ranking function by minimizing a query-dependent loss function employing query categories; and
using the optimal search ranking function to rank search results returned in response to a search query.

2. The computer-implemented process of claim 1 wherein each query category represents one type of ranking objective.

3. The computer-implemented process of claim 1 wherein the ranking function employs the probability that a query belongs to a given class.

4. The computer-implemented process of claim 1 wherein the ranking function is learned using pre-determined query categories.

5. The computer-implemented process wherein the ranking function uses learned query categories.

6. The computer-implemented process of claim 5 wherein the ranking function is learned at the same time the query categories are learned while minimizing the query-dependent loss function.

7. The computer-implemented process of claim 1 wherein a query category further comprises one of a group comprising:
a navigational category relating to a user navigating to a given location on a network;
a transactional category relating to a user completing a transaction on a network; and
an informational category relating to a user seeking information on a topic on a network.

8. The computer-implemented process of claim 1 wherein the query categories are used to learn the search result ranking function, but are not used to rank the search results returned in response to a search query.

9. The computer-implemented process of claim 1 wherein each query category has its own type of loss function.

10. A computer-implemented process for learning to rank results returned in response to a search query, comprising,
using a computer for,
creating a query-dependent loss function dependent on query categories for use in search result ranking;
training a search result ranking function using the created query-dependent loss function to rank search results returned in response to a search query.

11. The computer-implemented process of claim 10, further comprising using the ranking function to rank results returned in response to a search query.

12. The computer-implemented process of claim 10 wherein the query categories are predefined.

13. The computer-implemented process of claim 10 wherein the query categories are learned.

14. A system for determining web page importance, comprising:
a general purpose computing device;
a computer program comprising program modules executable by the general purpose computing device, wherein the computing device is directed by the program modules of the computer program to,
create an overall query-dependent loss function that determines a query-dependent loss function for each query category of a set of query categories;
train a ranking function that employs the overall query-dependent loss function to create a trained model to rank search results returned in response to a query; and
use the trained model to rank search results received in response to a new query.

15. The system of claim 14 wherein a gradient descent method is used to minimize the overall query-dependent loss function in order to create the trained ranking function.

16. The system of claim 14 wherein training data is used to train the ranking function, comprising training queries and their associated search results and relevance scores.

17. The system of claim 16 wherein the relevance scores are used to estimate rank positions of search results.

18. The system of claim 14 wherein query categories are learned in conjunction with training the ranking function.

19. The system of claim 14 wherein predetermined query categories are employed.

20. The system of claim 14 wherein the overall query-dependent loss function is a modified version of an existing loss function in a ranking function used for ranking search results.
